(19) United States
(12) Patent Application Publication
(10) Pub. No.: US 2005/0197920 A1
(43) Pub. Date: Sep. 8, 2005

(54) Systems and methods for electronic integration of business transactions

(76) Inventors: Timothy J. Weir II, St. Louis, MO (US); James J. Revetta, St. Louis, MO (US); Thomas C. Mulligan, Mascoutah, IL (US)

Correspondence Address: LATHROP & GAGE LC, 4845 PEARL EAST CIRCLE, SUITE 300, BOULDER, CO, 80301, US

(21) Appl. No.: 11/039,307

(22) Filed: Jan. 19, 2005

Related U.S. Application Data
(60) Provisional application No. 60/537,614, filed on Jan. 19, 2004.

(51) Int. Cl. G06F 17/60

(52) U.S. Cl. 705/26

(57) ABSTRACT

Provided is a system and method for integrating electronic business transactions within a community of buyers and sellers. The system includes at least one translating agent for translating data received from a buyer and/or a seller into a data format compatible with an application adapter. Further, a data format is selected to be compatible with the electronic business systems of both the buyer and the seller. Seamless execution of various application modules, such as an invoicing or a shipping module, is assured using any one of several known data formats, such as XML. The application adapter provides attended and unattended batch mode integration of received data, to ensure data integrity, delivery, proper application, and security.

### RELATED APPLICATIONS

This application claims benefit of priority to provisional application Ser. No. 60/537,614 filed Jan. 19, 2004, which is incorporated by reference to the same extent as though fully replicated herein.

### BACKGROUND

1. Field of the Invention

This invention relates generally to electronic business transactions. More particularly to improved methods and systems for automating an electronic exchange of business information between buyers and sellers to effect a business transaction.

2. Description of the Related Art

For many businesses the conventional method for conducting a business transaction, such as the buying and selling of goods and services, has not changed for decades. A buyer initiates a purchase order through data entry, and the purchase order is “manually” and often mechanically transmitted to a seller for execution. The transmittal may be, for example, in-person, via the U.S. Postal Service, via telephone, and/or via facsimile.

Once the seller receives the order, the seller enters the data necessary to effect a sale, to include shipping directions, the creation of an invoice, etc. As with the purchase order, the invoice and other sales related documents are “manually” transmitted to the buyer, who must then enter the necessary sales information into his or her accounting system (e.g. accounts payable). This entire buy-sell process is slow, inefficient, and ripe for human error.

Electronic Data Interchange (“EDI”) is a technique for rapidly, reliably, and economically conducting business. The widespread use of the Internet, and the extrapolation or extension of associated Internet technologies, have brought EDI and electronic commerce (eCommerce) within the affordability and feasibility range of virtually any business in any industry.

One of the most promising of the eCommerce scenarios to arise is the electronic Marketplace (“eMarketplace”). In particular, the advent of Internet sales through an eMarketplace permits operators to provide virtual sites where business may be conducted. Physical sales operations may be conducted at a central location—advantageously avoiding the need for a national chain of brick-and-mortar establishments. The eMarketplace provides buyers a secure and convenient forum in which to review, compare, and ultimately procure goods and services in a timely, efficient manner.

Sellers, meanwhile, may reduce sales expenses by displaying a wide range of available products to a large number of potential buyers in a single eMarketplace. Further, sellers may compete for the business of these buyers by offering special price or benefit arrangements in real time. The eMarketplace may also offer companies a conduit for trade with existing business partners, and a means of locating new business partners.

The benefits of the eMarketplace, in each of its embodiments, are quickly gaining recognition in the business community. However, despite its increasing popularity, the eMarketplace is not without its drawbacks.

While eMarketplace transactions offer many advantages to sellers, the lack of personal customer interaction makes it more challenging for sellers to add value to the buying or trading process. Furthermore, pricing and availability information may become readily available to competitors, who may then entice customers away from their initial seller via lower prices, special offers, and the like.

Additionally, businesses must take care to enter an eMarketplace focused upon their particular interests. The explosive growth of eMarketplaces brings with it the risk of companies potentially making investments with a wrong eMarketplace organization. For example, a particular eMarketplace may not be focused on a company's business, nor have attracted enough potential buyers or sellers to meet the company's needs. Additionally, a company must also consider whether a given eMarketplace is likely to survive the barrage of multiple competing eMarketplaces in the same industry.

Furthermore, not every eMarketplace will supply the software services that most benefit a particular company. Likewise, a particular eMarketplace may not necessarily integrate with a company's existing applications systems. It is the latter of these concerns, i.e. integration, that is perhaps the most crucial concern for companies dealing in eCommerce.

Integration issues are critical and require considerable forethought. For example, sellers may need eMarketplace transactions to interact with their order, inventory and catalog systems. Sellers may additionally require that purchase orders and invoices, generated through the eMarketplace, are integrated with their business systems. Further, buyers may desire exchanges that can input data directly into their purchasing and accounting systems.

Additionally, both buyers and sellers must decide which of their scarce resources will be allocated to online exchanges, and whether those resources are compatible with the eMarketplace. For example, integration of the eMarketplace to a company's “back office” application is becoming one of the most important criteria for evaluating and selecting an eMarketplace. For at least these reasons, integration is critical to a company entering the eMarketplace; however, current integration alternatives are inherently problematic.

Marketplace integration alternatives generally include support of XML (extensible Markup Language), a data format that is quickly becoming an Internet industry data standard for handling multiple business documents. XML compatible systems (i.e. company legacy systems) are therefore important, if not critical. However, a problem arises because not all versions of XML are compatible with one another. For example, building legacy systems to support an eMarketplace that is driven by the Commerce 1 technology, does not automatically mean that the systems will be compatible with an eMarketplace that is driven by the Ariba technology. Both Commerce 1 and Ariba are industry leaders in the sale of eMarketplace software technology, however they do not support the same version of XML.

This lack of consistency presents an obstacle to companies intending to participate in multiple eMarketplaces driven by different technologies. By necessity, many company integration strategies must address more than one version of XML, and the costs to do so are prohibitive. In contrast, companies that are confident that one eMarketplace (or a group of eMarketplaces utilizing the same version of XML) will suffice to service all major customers and/or meet purchasing requirements are likely to encounter problems if they adopt a single integration strategy.

A company utilizing an integration strategy that addresses a single version of XML (a “singly-integrated” company) may encounter difficulties when, for example, a major prospective customer requests that the company accept their purchase orders in a different XML data format. Similarly, that customer may request that the company accept purchase orders in an incompatible EDI data format. A singly-integrated company would also find itself in a precarious position if a major customer suddenly switched to an eMarketplace inconsistent with the company's selected XML integration strategy. The company would then face the prospect of either a) losing the customer's business, or b) investing in a new integration strategy, and possibly losing the customer's business in the process due to lengthy setup and integration times.

### SUMMARY

The present disclosure advances the art and overcomes problems articulated above by providing a system for facilitating electronic business transactions. In particular, and by way of example only, according to an embodiment, provided is a system for electronic integration of business transactions comprising: at least one translating agent for translating data received from an electronic business system of a buyer, and data received from an electronic business system of a seller, into a data format operable with the respective electronic business systems of both the buyer and the seller; and an application adapter for integrating the translated data received from the buyer and the translated data received from the seller, to effect a selected business transaction.

Further, in one embodiment a method of integrating electronic business transactions among a community of buyers and sellers is disclosed, comprising: receiving data at an Internet portal of a buyer and at an Internet portal of a seller; defining a format of the data received at the Internet portal of the buyer and the data received at the Internet portal of the seller; identifying a data format operable with an electronic business system of the buyer and an electronic business system of the seller; and translating the data received at the Internet portal of the buyer, and the data received at the Internet portal of the seller, into the data format operable with both the electronic business system of the buyer and the electronic business system of the seller, wherein the steps of defining, identifying and translating are automated and initiated following the receiving step.

Also, in one embodiment, provided is an Internet-based purchasing and selling system operable to facilitate and integrate business transactions among a community of buyers and sellers, comprising: a first translating agent installed at a level of an Internet portal of a buyer; a second translating agent installed at a level of an Internet portal of a seller; and an application adapter for integrating data received from an electronic business system of the buyer and data received from an electronic business system of the seller, to effect a selected business transaction, wherein the first and the second translating agents are operable to translate the data received from the electronic business system of the buyer, and the data received from the electronic business system of the seller, into a format recognized by the application adapter, the electronic business system of the buyer, and the electronic business system of the seller.

### BRIEF DESCRIPTION OF THE DRAWINGS

FIG. 1 is a schematic illustrating traditional business transactions;

FIG. 2 is a schematic of a system for facilitating an electronic business transaction, according to an embodiment; and

FIG. 3 is schematic illustrating the operational flow of electronic business transactions, according to an embodiment.

### DETAILED DESCRIPTION

Before proceeding with the detailed description, it is to be appreciated that the present teaching is by way of example, not by limitation. The concepts herein are not limited to use or application with one specific type of system for facilitating and integrating an electronic business transaction. Thus, although the instrumentalities described herein are for the convenience of explanation, shown and described with respect to exemplary embodiments, it will be appreciated that the principals herein may be equally applied in other types of systems for facilitating and integrating electronic business transactions.

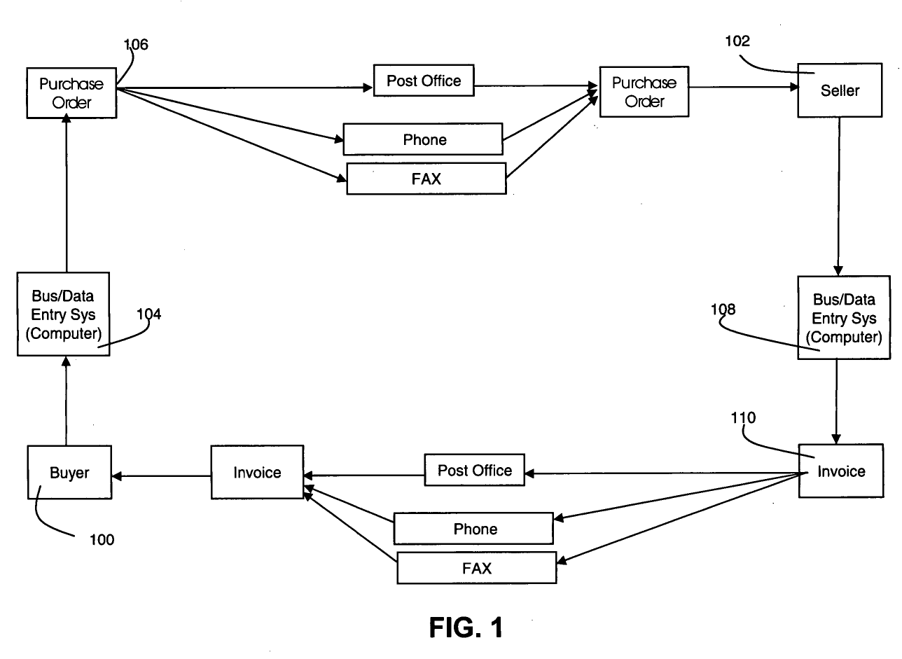

A traditional business transaction, between for example a buyer 100 and a seller 102, is shown in FIG. 1. The transaction includes a number of “manual” steps wherein the buyer 100 enters data into an electronic business system (e.g. computer based) 104, and the corresponding purchase order 106 is manually transmitted to the seller 102 via any number of relatively slow, inefficient transmission tools (U.S. Postal Service, facsimile, etc.). The seller 102, in turn, enters the required purchase order 106 data into its own electronic business system 108, and an invoice 110 is generated to accompany a shipment of goods. As with the purchase order 106, the invoice 110 is transmitted to the buyer 100 via a manual, often mechanical, approach.

As can be appreciated by referring to FIG. 1, many business transactions require the manual entry of relevant buy-sell data, as well as the handling of numerous documents. Automation of these steps can increase transaction efficiencies while lowering transaction costs, however, automation often requires compatible data formats.

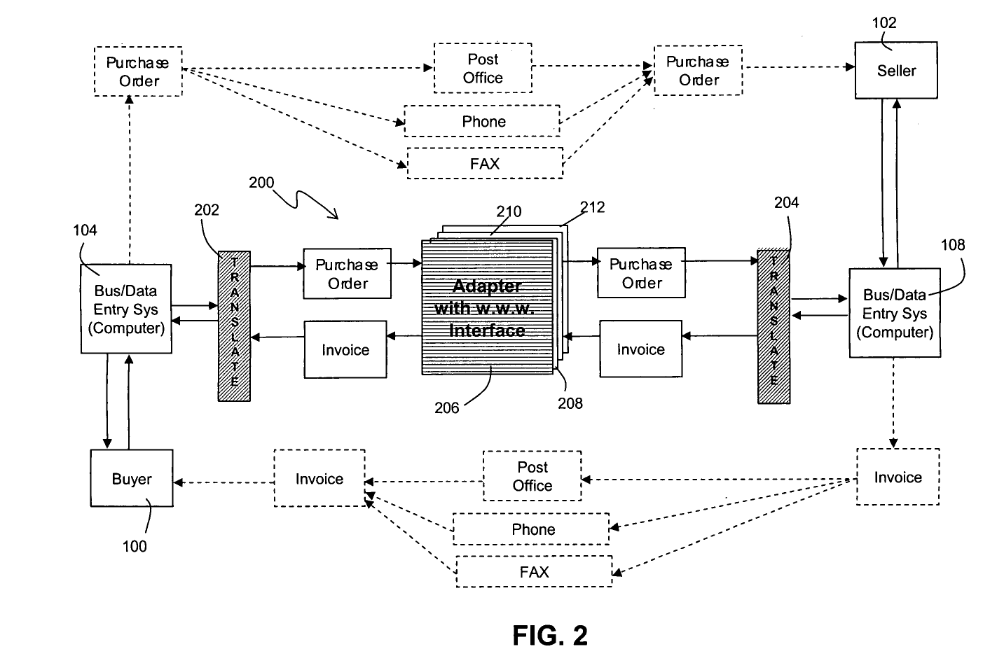

In FIG. 2, the business transaction of FIG. 1, for example the buying and selling of goods or services, is represented once again. It can be appreciated that FIG. 2 is representative of any business transaction, and the systems and methods disclosed herein apply equally to all. As shown, a system 200 for facilitating electronic business transactions is shown integrating the processes and needs of a buyer 100 with the processes and needs of a seller 102. Specifically, system 200 includes at least one translating agent, of which translating agents 202 and 204 are exemplary. The translating agents 202, 204 are integrated at a level of the buyer 100 and the seller 102. In particular, the translating agents 202, 204 interface the electronic business systems of the buyer 100 and the seller 102, systems 104 and 108 respectively, with an application adapter 206.

In this manner, translating agent 202 translates data received from the electronic business system 104 of the buyer 100 into a data format compatible with the application adaptor 206. Further, the selected data format may also be compatible with the electronic business system 108 of the seller 102. In at least one embodiment, translating agent 204 translates data received from the electronic business system 108 of the seller 102 into a data format compatible with the application adapter 206, and the electronic business system 104 of the buyer 100.

Application adapter 206 provides batch mode integration of received data, to ensure data integrity, delivery, and security. The batch mode operation may be unattended, thereby eliminating the need for a “man-in-the-loop” supervision of the batch process. In at least one embodiment, application adapter 206 operates using a variety of data formats, to include EDI (ANSI×12 and EDIFACT), XML and flat files. As represented in FIG. 2, application adapter 206 can integrate, using any of a number of data formats, business transactions and documents such as outbound purchase orders and inbound invoices.

Application adapter 206 may include one or more specific business transaction modules. For example, in one embodiment an invoicing module 208 is provided which operates to expedite and simplify invoicing procedures among a community of buyers and sellers. Invoicing module 208 advantageously expedites acquisition of sales in fulfillment of a procurement and/or a marketing function. More specifically, invoicing and payment functions are executed electronically as the payment data from business system 104 of buyer 100, and the invoicing data from business system 108 of seller 102, are made compatible with application adapter 206, and with each other. When executing invoicing module 208, translating agents 202 and 204 may include Internet portals operable to translate buyer 100 and seller 102 data for use by application adapter 206.

In yet another embodiment, a module 210 for creating advanced shipping notices is provided. The advanced shipping notice, or “ASN”, module 210 features powerful, EDI-compliant functionality that electronically packages and segregates a range of goods across multiple orders, thereby enabling users to apply shipping-related information to a collection of goods. The ASN module 210 reduces the need for manual data re-entry, thereby increasing operational efficiency. The ASN module 210 further allows precise and detailed packing of both single item codes and multi-trailers, while generating UCC-128 compliant data labels.

In one embodiment, system 200 provides for accurate, timely, bi-directional integration of electronic data between company accounting applications, such as QuickBooks. Application adapter 206 integrates inbound sales orders, customer data, and purchase orders, with outbound sales orders, posted invoices, customer data, purchase orders, and inventory data.

In this embodiment, system 200 works in concert with an accounting software package, such as QuickBooks, in either a batch or an unattended batch mode depending on the system requirements of both the buyer 100 and the seller 102. Operating in batch mode enables large volumes of document processing using pre-defined inbound and outbound profiles that follow a list of detailed actions. Profiles may also be initiated without user intervention in the unattended batch mode. The need for manual data re-entry is largely or completely eliminated as an accounting module 212 verifies and validates information before importing the information into the accounting package of either the buyer 100 or the seller 102. This approach reduces costs to both sellers 102 and buyers 100, as manually-entered errors in data are eliminated. Costs, including operational costs, are further reduced as the accounting module 212 achieves rapid EDI compliance and compatibility between buyers 100 and sellers 102.

It is to be appreciated that the embodiments disclosed herein are not exhaustive or all-inclusive. The system 200 and the modules (208, 210, 212) disclosed herein may facilitate any manner of electronic business transactions, allowing virtual anytime, anywhere transactions between a buyer 100 and seller 102. The system 200 is scalable, and may be tailored to the requirements of a particular business. The system 200 and methods further reduce the cost of conducting business by increasing the efficiency of transactions, business processes and inventory management, thereby freeing employees to focus on other aspects of the business.

Furthermore, manual business documents may be replaced by electronic documents, thereby saving money and resources. For example, faxes (e.g. purchase orders) may be wholly or partially replaced by computer-to-computer transactions, as may printed invoices. Optionally, printed catalogs may be replaced by online catalogs displayed on a company's website or sent to customers via email. The data found in such online catalogs is controlled by the company licensing the system 200. Therefore, the catalog data, including customer specific item pricing, is supported by system 200 in a manner which can be tailored to the particular needs of the company.

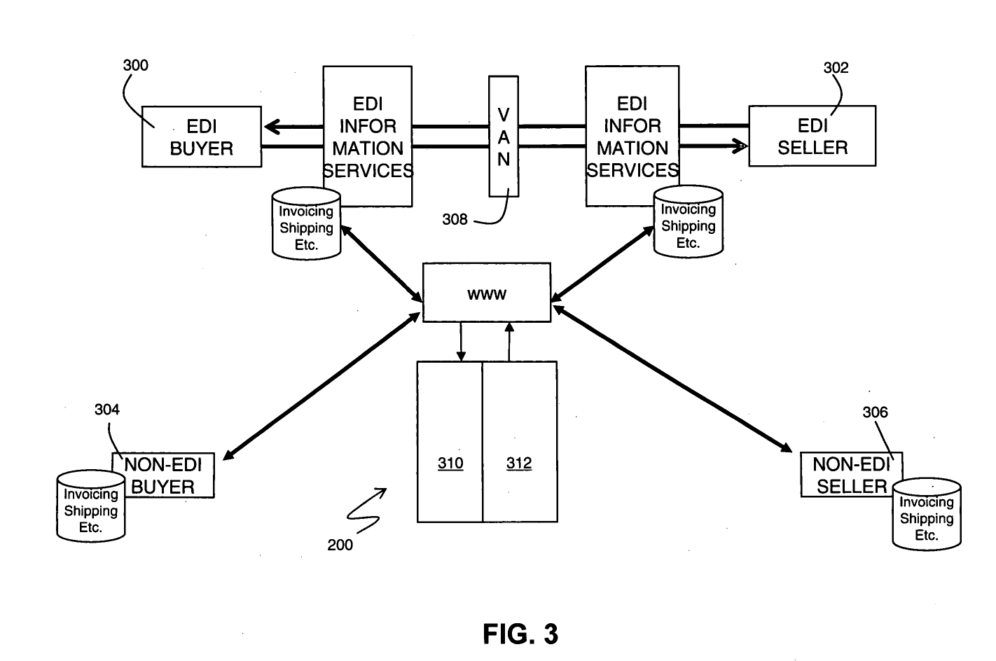

The ability to integrate with a wide variety of applications, or modules (e.g. modules 208, 210 and 212) provides a company significant freedom of operations. Referring now to FIG. 3, an operational implementation of system 200 is shown. By way of example, companies utilizing EDI, e.g. companies 300 and 302, as well as non-EDI companies, e.g. companies 304 and 306, can be integrated using system 200. A company may select the value added network (VAN) 308, Internet VAN (iVAN) (not shown), or translating agent 310 which best suits the EDI (data) requirements of the company and a particular transaction.

For example, company 300 may communicate directly with a second company 302 via a VAN 308, exchanging data to effect a business transaction. Alternatively, company 300 may conduct business with non-EDI company 306 via the Internet, translating agent 310 and application adapter 312. EDI data has traditionally been transferred over expensive private networks (VANS), and system 200 provides an economical alternative to VANS, as well as FTP and HTTP communication protocols. Using system 200, the exchange of relevant information, even between two apparently non-compatible business entities (e.g. company 300 and company 306), is bi-directional and automated. Functions such as product ordering, invoicing for product, shipping, etc. can be executed in an efficient, rapid, integrated manner.

System 200 may provide data translation applications designed to address multiple business documents or transactions simultaneously, as well as a number of different data structures, such as XML and EDI. Further, system 200 is quickly deployable, saving costs and resources and reducing time required for designing, coding, and implementing complex integration projects. It is to be understood that system 200 may provide mobile support in the field (locally) for capture of orders at the point of origin, thereby simplifying integration projects and expanding a company's ability to participate in eMarketplaces and connect with customers.

Changes may be made in the above methods, devices and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, device and structure, which, as a matter of language, might be said to fall therebetween.

1. A system for electronic integration of business transactions comprising:
at least one translating agent for translating data received from an electronic business system of a buyer, and data received from an electronic business system of a seller, into a data format operable with the respective electronic business systems of both the buyer and the seller; and
an application adapter for integrating the translated data received from the buyer and the translated data received from the seller, to effect a selected business transaction.

2. The system of claim 1, further comprising a means for generating an electronic record of the transaction.

3. The system of claim 1, wherein the application adapter operates in a batch mode.

4. The system of claim 1, wherein the application adapter operates in an unattended batch mode.

5. The system of claim 1, wherein the data received from the electronic business system of the buyer, and/or the data received from the electronic business system of the seller, is in an Electronic Data Interchange format.

6. The system of claim 1, wherein the data received from the electronic business system of the buyer, and/or the data received from the electronic business system of the seller, is in an extensible Markup Language format.

7. The system of claim 1, further comprising an advanced shipping module.

8. The system of claim 1, further comprising an accounting module.

9. A method of integrating electronic business transactions among a community of buyers and sellers, comprising:
receiving data at an Internet portal of a buyer and at an Internet portal of a seller;
defining a format of the data received at the Internet portal of the buyer and the data received at the Internet portal of the seller;
identifying a data format operable with an electronic business system of the buyer and an electronic business system of the seller; and
translating the data received at the Internet portal of the buyer, and the data received at the Internet portal of the seller, into the data format operable with both the electronic business system of the buyer and the electronic business system of the seller,
wherein the steps of defining, identifying and translating are automated and initiated following the receiving step.

10. The method of claim 9, wherein the data received at the Internet portal of the buyer and/or the data received at the Internet portal of the seller is in an Electronic Data Interchange format.

11. The method of claim 9, wherein the data received at the Internet portal of the buyer and/or the data received at the Internet portal of the seller is in an extensible Markup Language format.

12. The method of claim 9, further comprising integrating translated buyer and seller data to effect a selected business transaction between the buyer and the seller.

13. The method of claim 12, further comprising generating an electronic record of the transaction.

14. The method of claim 13, wherein the electronic record is an invoicing document.

15. The method of claim 13, wherein the electronic record is a shipping document.

16. An Internet-based purchasing and selling system operable to facilitate and integrate business transactions among a community of buyers and sellers, comprising:
a first translating agent installed at a level of an Internet portal of a buyer;
a second translating agent installed at a level of an Internet portal of a seller; and
an application adapter for integrating data received from an electronic business system of the buyer and data received from an electronic business system of the seller, to effect a selected business transaction,
wherein the first and the second translating agents are operable to translate the data received from the electronic business system of the buyer, and the data received from the electronic business system of the seller, into a format recognized by the application adapter, the electronic business system of the buyer, and the electronic business system of the seller.

17. The system of claim 16, wherein the application adapter operates in a batch mode.

18. The system of claim 16, wherein the application adapter operates in an unattended batch mode.

19. The system of claim 16, further comprising an accounting module.

20. The system of claim 16, further comprising an advanced shipping module.
